(19) United States
(12) Patent Application Publication
(10) Pub. No.: US 2009/0014198 A1
(43) Pub. Date: Jan. 15, 2009

(54) CORRUGATED TUBE WITH A LOCKING STRUCTURE

(75) Inventors: Masataka Shimizu, Yokkaichi-City (JP); Toshitsugu Morii, Yokkaichi-City (JP); Koji Kobayashi, Yokkaichi-City (JP); Masayuki Doi, Yokkaichi-City (JP); Yasunori Okuoka, Yokkaichi-City (JP)

Correspondence Address: CASELLA & HESPOS, 274 MADISON AVENUE, NEW YORK, NY, 10016, US

(73) Assignee: Sumitomo Wiring Systems, Ltd., Yokkaichi-City (JP)

(21) Appl. No.: 12/170,688

(22) Filed: Jul. 10, 2008

(30) Foreign Application Priority Data
Jul. 11, 2007 (JP) 2007-182369

(51) Int. Cl. H01B 7/18

(52) U.S. Cl. 174/102 R

(57) ABSTRACT

A corrugated tube has a slit (13) and first closing walls (14A) of circumferentially extending annular projections (12) are formed along the slit (13). Lock projections (16) dimensioned to be fitted inside the annular projections (12) are provided between the first closing walls (14A) and second closing walls (15A). The lock projections (16) are tapered toward the projecting ends thereof and clearances, into which the first closing walls (14A) are insertable are defined between the lock projections (16) and the second closing walls (15A). Out of the opposite ends (14, 15) of the annular projections (12), the ends corresponding to the first closing walls (14A) are fitted on the lock projections (16) to engage the first closing walls (14A) and the lock projections (16), thereby locking the slit (13) in a closed state.

### BACKGROUND OF THE INVENTION

1. Field of the Invention

The invention relates to a corrugated tube provided with a locking structure.

2. Description of the Related Art

A corrugated tube formed with a longitudinal slit is known conventionally for mounting on a specified position of a wire group. This corrugated tube can be fit sideways on the specified position of the wire group by opening the slit. However, the slit of the corrugated tube is opened when the wire group is bent. Therefore taping or the like needs to be applied.

U.S. Pat. No. 6,078,009 relates to a corrugated tube with a locking structure for locking the slit in a closed state so that taping is unnecessary This corrugated tube is constructed to lock the slit by forming mutually engageable locking recesses at the opposite ends of the annular projections (opposite ends facing at the opposite sides of the slit) and engaging these locking recesses.

However, the above construction has a problem when using the corrugated tube with a mounting member, such as a protector, thereon because the mounting member easily gets caught by the locking recesses of the annular projections if an attempt is made to rotate the mounting member in a circumferential direction of the corrugated tube.

The present invention was developed in view of the above situation and an object thereof is to preventing a mounting member from getting caught in a circumferential direction even if having a locking structure.

### SUMMARY OF THE INVENTION

The invention relates to a corrugated tube with circumferentially extending projections at specified intervals in a longitudinal direction and a slit formed substantially in the longitudinal direction. Opposite ends of projections at opposite sides of the slit are closed substantially by closing walls. A first of the substantially opposite closing walls is formed substantially along the slit. One or more lock projections are provided between the first closing walls and the second closing walls and are dimensioned to fit at least partly inside the projections. Clearances are defined between the lock projections and the second closing walls for receiving the first closing wall. The first closing walls and the lock projections are engaged to lock the slit in a closed state when ends near the first closing walls are fit on or to the lock projections. The outer shape of the corrugated tube with the slit locked is approximate to that of a normal corrugated tube. Accordingly, the corrugated tube will not get caught by a mounting member in a circumferential direction even though the locking structure is provided.

The lock projections preferably are tapered towards the projecting ends thereof. Thus, the corrugated tube can be produced by a blow molding method similar to the normal corrugated tube.

Guide surfaces are formed on the lock projections facing the slit and are inclined to increase a projecting distance gradually towards the second closing walls of the annular projections. Thus, the first closing walls are guided by the guiding surfaces of the lock projections to pass the lock projections over merely by closing the slit. Therefore the ends of the annular projections need not be lifted up and a locking operation can be performed easily.

Ribs may be formed between the lock projections and the second closing walls to increases the rigidity of parts between the second closing walls and the lock projections and to prevent the lock projections from being inclined. Therefore, the slit can be held locked with an increased force.

The ribs may be provided at positions substantially corresponding to the widthwise centers of the lock projections.

The lock projections may be provided in a one-to-one correspondence with all of the preferably annular projections. Thus, the slit reliably is held closed.

The ribs may be provided in a one-to-one correspondence with all of the lock projections. Thus, the inclination of all of the lock projections is prevented and the slit is held closed with even a larger force.

The lock projections may have a substantially trapezoidal shape when viewed in directions along the circumferential and longitudinal directions of the corrugated tube.

The corrugated tube may be produced by blow molding or vacuum molding.

These and other objects, features and advantages of the present invention will become more apparent upon reading of the following detailed description of preferred embodiments and accompanying drawings. It should be understood that even though embodiments are separately described, single features thereof may be combined to additional embodiments.

### DETAILED DESCRIPTION OF THE PREFERRED EMBODIMENTS

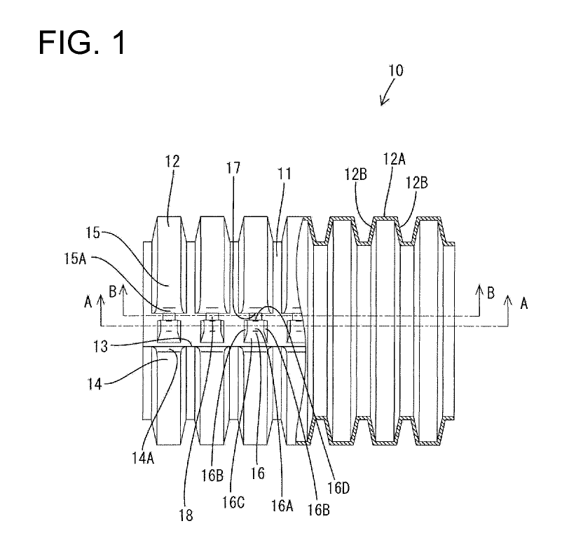

FIG. 1 is a side view partly in section showing a corrugated tube of one embodiment.

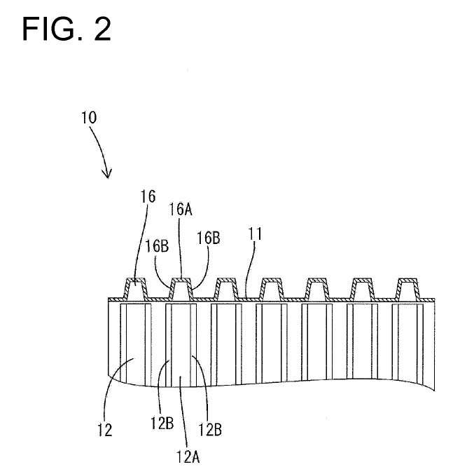

FIG. 2 is a section along A-A of FIG. 1.

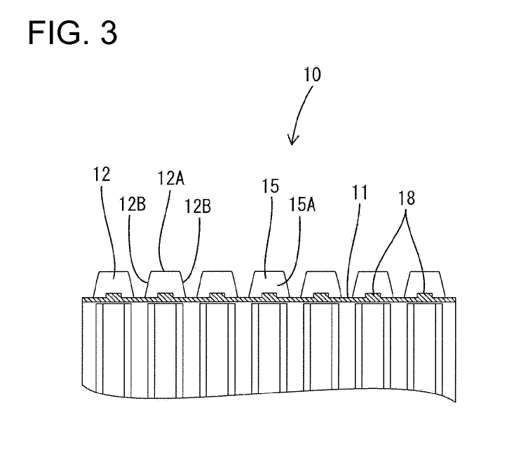

FIG. 3 is a section along B-B of FIG. 1.

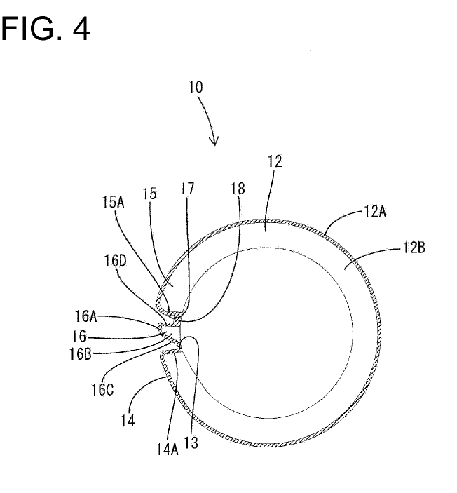

FIG. 4 is a section showing a state before a slit is locked in a closed state.

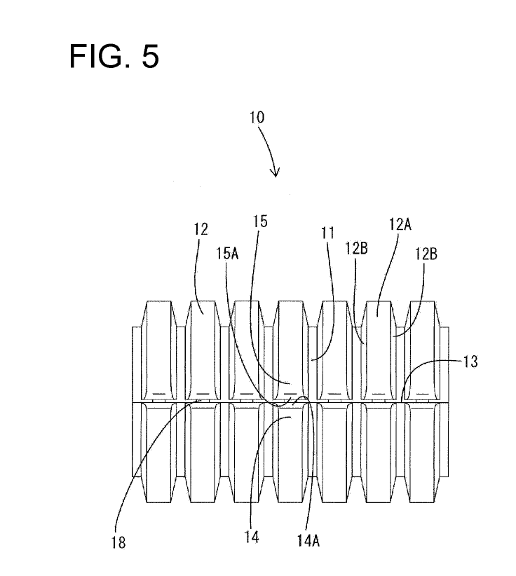

FIG. 5 is a side view showing a state where the slit is locked closed.

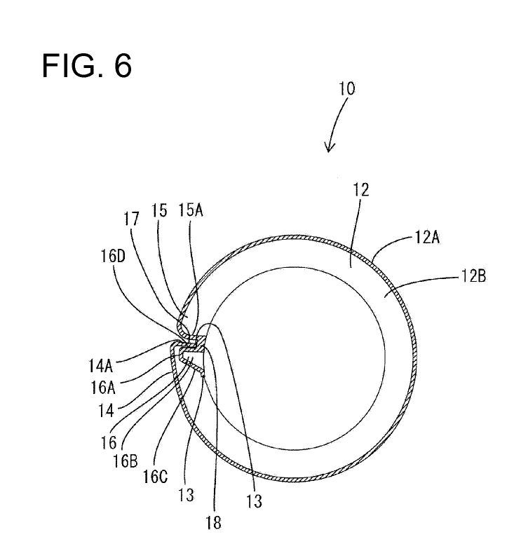

FIG. 6 is a section showing the state where the slit is locked closed.

### DETAILED DESCRIPTION OF THE PREFERRED EMBODIMENTS

A corrugated tube in accordance with the invention is identified by the numeral 10 in FIGS. 1 to 10. The corrugate tube 10 is to be mounted on a specified position on an unillustrated wire group for substantially surrounding and protecting the wire group. The corrugated tube 10 is made e.g. of synthetic resin and has a bellows or wave-like shape with annular projections 12 that project at specified intervals from a substantially cylindrical inner wall 11. Additionally, the corrugate tube 10 has sufficient flexibility to follow a layout path of the wire group. A substantially straight slit 13 is formed over the entire length of the corrugate tube 10 longitudinal direction.

Each annular projection 12 has a first end 14 at the slit 13 and a second end 15 spaced from the slit 13. The first and second ends 14 and 15 of each annular projection 12 substantially face one another at the opposite sides of the slit 13.

Each annular projection 12 has a projecting end surface 12A that is substantially parallel to the inner wall 11 of the corrugated tube 10 and opposite side surfaces 12B that converge towards the projecting end surface 12A. Thus, each annular projection narrows towards the projecting end surface 12A and the distance between adjacent annular projections increases at positions closer to the projecting end surfaces 12A. The respective annular projections 12 have substantially isosceles trapezoidal cross sections when viewed in a direction along the circumferential direction of the corrugated tube 10.

The first and second ends 14 and 15 of each annular projection 12 are closed respectively by first and second closing walls 14A and 15A. The first and second closing walls 14A, 15A have substantially trapezoidal shapes and close the ends of the annular projection 12 by having peripheral edges continuous with the side surfaces 12B of the annular projection 12, the projecting end surface 12A of the annular projection 12 and the inner wall 11. The first closing walls 14A are formed along the slit 13 so that the slit 13 extends substantially straight in the longitudinal direction along the first closing walls 14A.

Lock projections 16 project from the inner wall 11 at positions between the second closing walls 15A and the slit 13 and between the first and second closing walls 14A, 15A at positions aligned with the annular projections 12. One lock projection 16 is provided for each annular projection 12 and is at a position slightly distanced from the slit 13 towards the corresponding closing wall 15A (see FIG. 1).

Each lock projection 16 has a projecting end surface 16A that is substantially parallel to the inner wall 11 and opposite side surfaces 16B that converge towards the projecting end surface 16A. Thus, the spacing between the side surfaces 16B on adjacent lock projections 16 increases at positions closer to the projecting end surfaces 16A (see FIG. 2). A guiding surface 16C is formed on each lock projection 16 facing the slit 13 and is inclined to gradually increase a distance to the second closing wall 15A, as shown in FIG. 4. A locking surface 16D is formed on a portion of each lock projection 16 facing the second closing wall 15A and is aligned substantially perpendicular to the inner wall 11 of the corrugated tube 10. The locking surface 16D and the second closing wall 15A are substantially parallel, and a clearance of two or more times the thickness of the first closing wall 14A is defined therebetween. An insertion portion 17 is defined between the locking surface 16D and the second closing wall 15A for receiving the first closing wall 14A.

All of the lock projections 16 have a substantially trapezoidal shape when viewed in directions along the circumferential and longitudinal directions of the corrugated tube 10. The respective lock projections 16 are dimensioned to fit closely into the corresponding annular projections 12. More specifically, with the respective lock projections 16 fit in the first ends 14 of the corresponding annular projections 12, the substantially opposite side surfaces 16B of the lock projections 16 have substantially the same inclinations as the opposite side surfaces 12B of the annular projections 12 and are arranged proximate to these side surfaces 12B.

Ribs 18 are formed on the inner wall 11 of the corrugated tube 10 between the locking surfaces 16D of the locking projections 16 and the second closing walls 15A. The ribs 18 are provided in a one-to-one correspondence with the locking projections 16 and are arranged at positions corresponding to the widthwise centers of the respective locking projections 16 along the longitudinal direction of the corrugated tube 10 and project unitarily from the inner wall 11 while spanning between the locking surfaces 16D and the second closing walls 15A. In this way, parts of the inner wall 11 between the locking projections 16 and the second closing walls 15A where the ribs 18 are provided have a larger wall thickness in inward and outward directions due to the thickness of the ribs 18 as compared with other parts.

The slit 13 of the corrugated tube 10 is opened and the corrugated tube 10 is fit sideways or substantially radially on the wire group or any other element to be protected. The first closing walls 14A are guided by the respective inclined guiding surfaces 16C of the locking projections 16 and move onto the projecting end surfaces 16A as the slit 13 is closed. The first closing walls 14A pass the projecting end surfaces 16A of the locking projections 16 as the slit 13 is closed further and enter into the inserting portions 17. The inserting portions 17 are slightly larger than the thickness of the first closing walls 14A. Thus, the first closing walls 14A enter the inserting portions 17 in inclined postures.

The locking surfaces 16D of the locking projections 16 face the first closing walls 14A when first closing walls 14A are inserted into the inserting portions 17 to lock the slit 13 in a closed state. More particularly, the first ends 14 of the annular projections 12 are fit on the locking projections 16 and only tiny clearances are left between the first closing walls 14A in the inserting portions 17 and the second closing walls 15A. Therefore the annular projections 12 are substantially continuous without any projections or recesses over the entire circumference. In other words, with the slit 13 locked in the closed state, the projecting end surfaces 12A and side surfaces 12B of the annular projections 12 of the corrugated tube 10 and the inner wall 11 have smooth substantially cylindrical shapes free from projections and recesses over substantially the entire circumference, and the corrugated tube 10 approximates the outer shape of a normal corrugated tube (i.e. a slit-free corrugated tube or a corrugated tube having no locking structure even if formed with a slit) (see FIGS. 5 and 6). Accordingly, a mounting member, such as a protector, can be mounted on the corrugated tube 10 and can be rotated smoothly without getting caught by the mounting member in the circumferential direction.

The lock projections 16 are tapered toward their projecting ends. Thus, the corrugated tube 10 can be produced by a blow molding method similar to the conventional corrugate tube.

The first closing walls 14A are guided by the guiding surfaces 16C of the lock projections 16 to move over the lock projections 16 while locking the slit 13 in the closed state. Thus, the first ends 14 need not be lifted up to fit on the lock projections 16 so that the locking operation can be performed easily.

The lock projections 16 are provided for all of the annular projections 12 and the slit 13 is locked at all of the annular projections 12. Thus, the slit 13 is held reliably closed over substantially the entire length of the corrugated tube 10.

The opposite side surfaces 16B of the lock projections 16 are substantially parallel to the opposite side surfaces 12B of the annular projections 12 when the first ends 14 fit on the lock projections 16. Thus, the side surfaces 16B of the lock projections 16 the contact side surfaces 12B of the annular projections 12 to prevent relative displacements of the respective lock projections 16 and first ends 14 in the longitudinal direction if the corrugated tube 10 is bent. Therefore, relative displacements of the opposite ends 14, 15 of the annular projections 12 in the longitudinal direction are restricted and the annular projections 12 are kept substantially continuous in the circumferential direction.

The ribs 18 between the lock projections 16 and the second closed walls 15 increase rigidity so that these parts are difficult to bend even upon the action of contact forces of the lock projections 16 and the first closing walls 14A. Specifically, the ribs 18 provide rigidity against bending deformation in a direction that would displace the lock projections 16 inwardly of the corrugated tube 10 and prevent the lock projections 16 from being inclined. Accordingly, the lock projections 16 and the first closing walls 14A are unlikely to disengage from each other even if relatively large forces act on the lock projections 16 while bending the corrugated tube 10. Hence, the slit 13 remains closed. Further, the ribs 18 are at positions substantially corresponding to the widthwise centers of the lock projections 16. Thus, the ribs 18 provide well balanced resistance to bending deformations that could incline the lock projections 16. The ribs 18 are provided for all of the lock projections 16. Thus, the inclination of all of the lock projections 16 are prevented and the slit 13 is held closed with an increased force.

As described above, the outer shape of the corrugated tube 10 in the locked state of the slit 13 is approximate to the outer shape of a normal corrugated tube. Thus, the corrugated tube 10 will not get caught by a mounting member in the circumferential direction despite the existence of the locking structure.

The invention is not limited to the above described embodiment. For example, the following embodiments also are embraced by the scope of the invention as defined by the claims.

Although the invention is applied to the corrugated tube 10 having the slit 13 formed over the entire length in the above embodiment, it is also applicable to a corrugated tube having a slit partly formed. Moreover, the corrugate tube may have a cross-sectional shape different from a substantially circular one such as a polygonal, squared, rectangular, elliptical or the like shape.

Although the lock projections 16 are substantially trapezoidal when viewed in both the circumferential direction and the longitudinal direction in the above embodiment, the lock projections may have any shape provided that they are dimensioned to be fit inside the annular projections and are tapered towards the projecting ends. For example, the lock projections may have a triangular pyramidal shape. Moreover, the projections of the corrugated tube need not to be annular, but may have different shapes such as a substantially spiral shape so that one end of one projection may oppose an end of another projection.

The inserting portions 17 are slightly larger than the wall thickness of the first closing walls 14A in the above embodiment, but they may not be larger.

Surfaces of the lock projections 16 facing the slits 13 are inclined in the above embodiment, but these surfaces may not necessarily be inclined surfaces.

The ribs 18 are formed between the lock projections 16 and the second closing walls 15A in the above embodiment. However, they may not be formed.

The ribs 18 are at the widthwise centers of the lock projections 16 in the above embodiment. However, they may be displaced from the center positions.

The lock projections 16 are provided for all the annular projections 12 in the above embodiment. However, the lock projections may be provided for fewer than all annular projections, e.g. every other annular projection.

The ribs 18 are provided for all the lock projections 16 in the above embodiment. However, ribs may be provided only for some lock projections.

The corrugated tube 10 is produced by the blow molding in the above embodiment, but it may be produced by other methods (e.g. vacuum molding).

What is claimed is:

1. A corrugated tube (10), comprising:
a plurality of circumferentially extending projections (12) arranged at specified intervals in a longitudinal direction;
a slit (13) formed substantially in the longitudinal direction;
a first closing wall (14A) at a first end of each of said projections (12) and at a first longitudinal side of the slit (11);
a second closing wall (15A) at a second end of each of said projections (12) and in proximity to a second longitudinal side of the slit (11);
lock projections (16) disposed respectively between the second closing walls (15A) and the second longitudinal side of the slit (11), each of the lock projections (16) being dimensioned to fit inside the projections (12); and
clearances being defined between the lock projections (16) and the second closing walls (15A) and being dimensioned to receive the first closing walls (14A) to lock the slit (13) in a closed state.

2. The corrugated tube (10) of claim 1, wherein the lock projections (16) are tapered toward the projecting ends thereof.

3. The corrugated tube (10) of claim 1, wherein guiding surfaces (16C) are formed on the lock projections (16) substantially facing the slit (13), the guiding surfaces (16C) being inclined to gradually increase a projecting distance toward the second closing walls (15A) of the projections (12).

4. The corrugated tube of claim 1, wherein ribs (18) are formed between the lock projections (16) and the second closing walls (15A).

5. The corrugated tube of claim 4, wherein the ribs (18) are at positions substantially corresponding to widthwise centers of the lock projections (16).

6. The corrugated tube of claim 5, wherein the ribs (18) are provided in a one-to-one correspondence with all of the lock projections (16).

7. The corrugated tube of claim 1, wherein the lock projections (16) are provided in a one-to-one correspondence with all of the projections (12).

8. The corrugated tube of claim 1, wherein the lock projections (16) have a substantially trapezoidal shape when viewed in directions along the circumferential and longitudinal directions of the corrugated tube (10).

9. The corrugated tube of claim 1, wherein the corrugated tube (10) is produced by blow molding or a vacuum molding.
